(19) United States
(12) Patent Application Publication
(10) Pub. No.: US 2010/0284268 A1
(43) Pub. Date: Nov. 11, 2010

(54) Node State Recovery for a Communication Network

(76) Inventor: Shan Zhu, Plano, TX (US)

Correspondence Address: BAKER BOTTS L.L.P., 2001 ROSS AVENUE, SUITE 600, DALLAS, TX, 75201-2980, US

(21) Appl. No.: 12/437,320

(22) Filed: May 7, 2009

(51) Int. Cl. H04L 12/26; H04L 12/28

(52) U.S. Cl. 370/217; 370/400

(57) ABSTRACT

Recovering state information for a node in a communication network includes receiving a path message after occurrence of a fault condition. A unique path identifier associated with the path message may be compared to at least one stored unique path identifier. In response to a determination that the unique path identifier associated with the path message matches at least one stored unique path identifier, path resource requirements associated with the path message may be compared to previously-committed resources associated with the at least one stored unique path identifier. In response to a determination that the path resource requirements associated with the path message match previously-committed resources associated with the at least one stored unique path identifier, a communications channel may be maintained through the node using the previously-committed resources and based on path information set forth in the path message.

### TECHNICAL FIELD

This invention relates generally to the field of communication networks and more specifically to state recovery for a node in a communication network.

### BACKGROUND

A communication network includes paths of nodes that route packets through the network. From time to time, a node along a path may experience a fault, and lose information associated with its path membership and allocated resources. Known techniques for recovering such path membership and allocated resource information rely on an exchange of messages between a recovering node and a neighboring node in the network. Such techniques, however, may be inefficient and lead to decreased network performance where such messages are not properly exchanged.

### SUMMARY OF THE DISCLOSURE

In accordance with the present invention, disadvantages and problems associated with previous techniques for node state recovery may be reduced or eliminated.

According to one embodiment of the present invention, a method for recovering state information for a node in a communication network comprises receiving a path message after an occurrence of a fault condition at the node. A unique path identifier associated with the path message may be compared to at least one stored unique path identifier. In response to a determination that the unique path identifier associated with the path message matches at least one stored unique path identifier, path resource requirements associated with the path message may be compared to previously-committed resources associated with the at least one stored unique path identifier. In response to a determination that the path resource requirements associated with the path message match previously-committed resources associated with the at least one stored unique path identifier, a communications channel may be maintained through the node using the previously-committed resources and based on path information set forth in the path message.

Certain embodiments of the invention may provide one or more technical advantages. A technical advantage of one embodiment may be that a node may recover its path state after a fault in a manner independent from its upstream neighbor node's ability to detect the fault condition of the faulting/recovering node and/or the upstream neighbor node's ability to successfully communicate recovery information to the recovering node. By leveraging information stored in a network element or data plane of a recovering node, the recovering node may be able to recover its state without communicating the fault condition to its upstream neighbor node or receiving recovery information from the upstream neighbor node. Such an approach may reduce the occurrence of degraded network performance associated with traditional approaches to state recovery.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating a network system according to one embodiment of the present disclosure; and

FIG. 2 is a flowchart illustrating one embodiment of a method of recovering node state information that may be used with network system of FIG. 1.

### DETAILED DESCRIPTION OF THE DRAWINGS

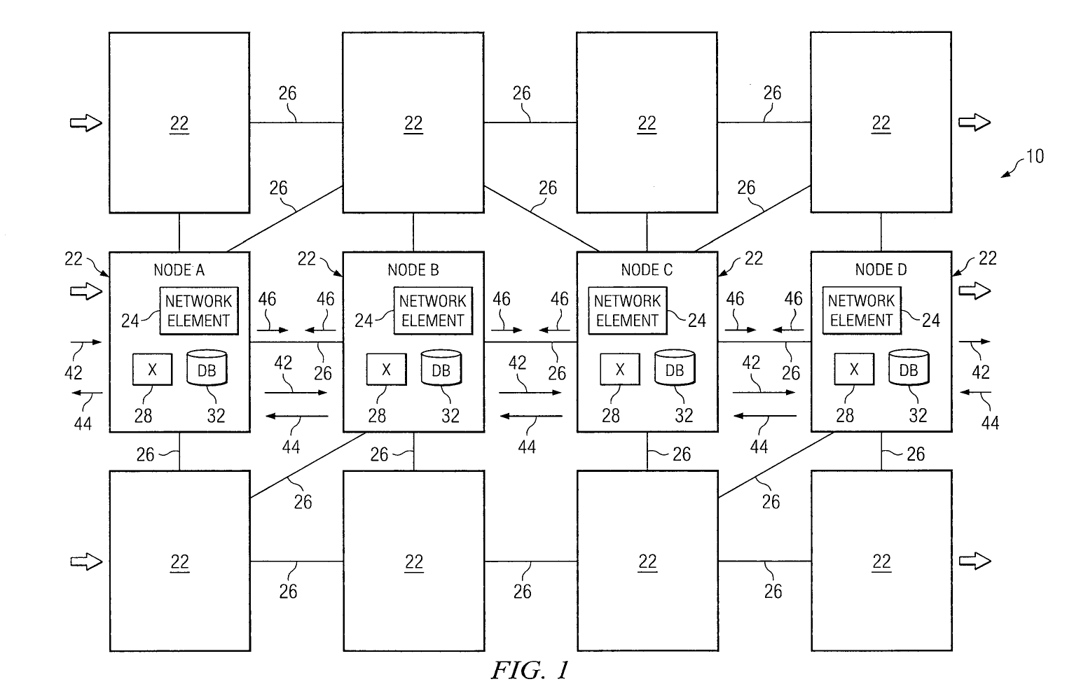

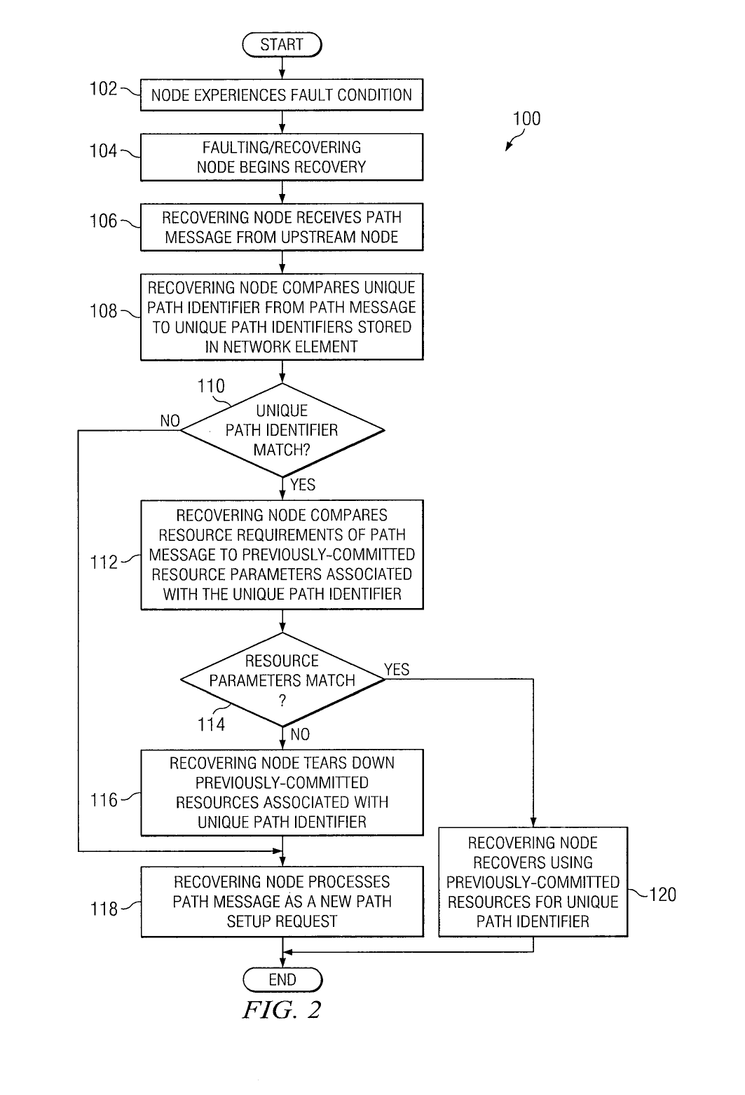

Embodiments of the present invention and its advantages are best understood by referring to FIGS. 1 and 2 of the drawings, like numerals being used for like and corresponding parts of the various drawings.

FIG. 1 is a block diagram illustrating a network system 10 according to one embodiment of the present disclosure.

System 10 includes components such as network nodes. In general, a network node may include any suitable arrangement of components operable to perform the operations of the network node. As an example, a network node may include logic, an interface, memory, other component, or any suitable combination of the preceding. “Logic” may refer to hardware, software, other logic, or any suitable combination of the preceding. Certain logic may manage the operation of a device, and may comprise, for example, a processor. “Processor” may refer to any suitable device operable to execute instructions and manipulate data to perform operations.

“Interface” may refer to logic of a network node operable to receive input for the network node, send output from the network node, perform suitable processing of the input or output or both, or any combination of the preceding, and may comprise one or more ports, conversion software, or both.

“Memory” may refer to logic operable to store and facilitate retrieval of information, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

Network system 10 communicates information through signals. A signal may refer to an optical signal transmitted as light pulses. As an example, an optical signal may have a frequency of approximately 1550 nanometers and a data rate of 10, 20, 40, or over 40 gigabits per second. A signal may alternatively refer to an electrical signal.

A signal may communicate information in packets. A packet may comprise a bundle of data organized in a specific way for transmission, and a frame may comprise the payload of one or more packets organized in a specific way for transmission. A packet may carry any suitable information such as voice, data, audio, video, multimedia, control, signaling, other information, or any combination of the preceding. The packets may comprise any suitable packets, such as Internet Protocol (IP) packets or time division multiplexed (TDM) packets.

According to the illustrated embodiment, network system 10 may include one or more networks. A network may include nodes 22 coupled by fibers 26 in a mesh topology as shown in FIG. 1 or any other suitable topology.

According to one embodiment, a network may utilize standards such as the Multi-Protocol Label Switching (MPLS) standard. MPLS may refer to a highly-scalable, protocol-agnostic, data-carrying mechanism. In an MPLS network, data packets may be assigned labels such that packet-forwarding decisions are made based on the contents of the label, without the need to examine other contents of the packet. Thus, MPLS may allow creation of end-to-end circuits using any transmission protocol across any type of transport medium, such as Ethernet, Synchronous Optical Network (SONET), or wavelength division multiplexing (WDM) (such as dense wavelength division multiplexing (DWDM)) techniques, for example.

A node 22 routes a packet to a next node 22 of a path according to the destination address of the packet (e.g., a destination address set forth in the label of an MPLS-labeled packet). Typically, the destination address specifies a node identifier, such as an Internet Protocol (IP) address, that uniquely identifies a destination node 22. A node 22 may have a table that specifies an output port for a given destination address.

According to an embodiment, a path, or circuit, may refer to a sequence of nodes 22 comprising endpoint nodes 22 and zero or more intermediate nodes 22 between the endpoint nodes 22. Endpoint nodes 22 may include an ingress node 22 and an egress node 22. An ingress node 22 may refer to a node 22 at which a packet enters network system 10, and an egress node 22 may refer to a node 22 at which the packet exits network system 10. Accordingly, a packet may travel from an ingress node 22, through the zero or more intermediate nodes 22, to an egress node 22. Example path types include unidirectional, bidirectional, drop and continue, broadcast, or multicast path types.

An endpoint node 22 may be identified in any suitable manner. According to one embodiment, a node 22 may be identified as an endpoint node 22 if the node 22 is a network facility, if the node 22 comprises a WDM interface that has no neighbor node 22, or if the node 22 does not have a provisioned cross connect 28.

Network system 10 may also utilize Resource Reservation Protocol (RSVP) or another protocol configured to reserve resources (e.g., bandwidth) within network system 10. RSVP and other similar protocols may be used to request or deliver specific levels of quality of service (QoS) for data streams. For example, in the embodiment shown in FIG. 1, RSVP may define how resource reservations may be placed in network system 10 and how such resource reservations may be relinquished once the need for them has ended. For example, use of RSVP may result in resources being reserved in each node 22 along a path.

Path messages travel hop by hop from an ingress node to an egress node. According to the illustrated example, path messages flow from node A through nodes B and C to node D. When describing relationships among nodes 22 in network system 10, the term “downstream” may be used to refer to a node 22 that is in the direction of path message flow relative to another node 22, while the term “upstream” may be used to refer to a node 22 that is opposite of the direction of path message flow relative to another node 22 (e.g., node B is upstream of node C and downstream of node A).

Path information may refer to information describing one or more paths. As an example, path information may include the sequence of nodes 22 included in a path. According to one embodiment, path information may also include monitoring information. Monitoring information may refer to information that may be used to monitor network system 10. Monitoring information may include, for example, information describing the performance and condition of network system 10. In the same or alternative embodiments, path information may also include a unique path identifier for each of one or more paths. In MPLS-based networks, path information may be set forth in the MPLS labels assigned to individual packets, and thus packets may be routed in accordance with information set forth in such labels.

A node 22 may include any suitable devices. According to the illustrated embodiment, a node 22 includes a network element 24, a cross connect 28, and a database 32. A network element 24 may include any suitable device operable to route packets to or from network 20. Examples of network elements 24 include dense wavelength division multiplexers (DWDMs), access gateways, endpoints, softswitch servers, trunk gateways, access service providers, Internet service providers, or other device operable to route packets to or from ring network 20. In some embodiments, network element 24 may also include a device operable to store certain information, for example unique path identifiers for one or more paths comprising the node 22 associated with the network element 24 and/or variables indicative of the node resources (e.g., bandwidth and/or quality of service) allocated to such paths. In these embodiments, such information may be stored on a persistent storage medium.

A cross connect 28 may comprise a coupling device that couples hardware coupled to the input and output ports of the cross connect 28. According to one embodiment, fiber patch cords may be used to make the circuit connections. Cross connect 28 may be incorporated with or separate from network element 24. A cross connect 28 may map a specific input port to a specific output port such that a packet received at the input port is routed to the output port. According to one embodiment, this mapping may be used to discover the paths of network system 10.

A database 32 may comprise a device operable to store path information and/or link state information, for example, a link state database (LSDB). Link state information describes the links and paths of network system 10.

Network system 10 may include any suitable number of fibers 36. Fibers 36 may refer to any suitable fiber operable to transmit a signal between two or more nodes 22. According to one embodiment, a fiber 36 may represent an optical fiber. An optical fiber typically comprises a cable made of silica glass or plastic. The cable may have an outer cladding material around an inner core. The inner core may have a slightly higher index of refraction than the outer cladding material. The refractive characteristics of the fiber operate to retain a light signal inside of the fiber. In the same or alternative embodiments, one or more nodes 22 may be coupled via any other suitable transmission medium (e.g., electrically-conductive wire and/or wireless transmissions).

According to one embodiment of operation, creation of one or more paths in network system 10 may involve gathering path information describing the paths of network system 10, and distributing the path information through network system 10. Path information may be gathered by sending path message 42 from an ingress node 22, through zero or more intermediate nodes 22, to an egress node 22.

Path message 42 may travel in any suitable direction through nodes 22, for example, in the direction of the flow of traffic 40 or opposite to the direction of the flow of traffic 40. Path message 42 may gather path information as it passes through nodes 22 from an ingress node 22 to an egress node 22. The path information may be gathered according to any suitable method. Egress node 22 may collect the gathered path information, and send the path information back to ingress node 22 in a return message 44. The path information may be stored at databases 32 of ingress node 22.

In one example, path message 42 and return message 44 may perform other operations in addition to gathering path information. In the example, path message 42 and return message 44 may be used to reserve resources, for example, bandwidth (e.g., using RSVP as discussed above). For example, path message 42 may comprise an RSVP path message, and return message 44 may comprise an RSVP reservation-request message.

In the example, path message 42 may describe requested resources, for example, bandwidth requirements, quality of service requirements, and/or parameters of data to be sent. The path messages 42 may be propagated from an ingress node 22 through intermediate nodes 22 to egress nodes 22. Each egress node 22 interested in the data may confirm the flow by sending a reservation-request message through the network. The reservation-request message describes the bandwidth characteristics of the data to be received from the ingress node 22. As the reservation-request messages propagate back towards the ingress node 22, intermediate nodes 22 determine whether or not to accept the proposed reservation and commit resources (e.g., bandwidth and/or quality of service) based on their capacity. If an intermediate node 22 decides to accept the proposed reservation, the resources are committed and the reservation-request message is propagated to a next node 22 in the path. When resources are committed at a particular node 22, parameters regarding the committed resources (e.g., bandwidth, quality of service, unique path identifiers) may be stored in the database 32 and/or network element 24 associated with the particular node 22.

The path information stored at databases 32 may be distributed to other nodes 22. According to one embodiment, path information may be distributed using a routing protocol, such as the Open Shortest Path First (OSPF) routing protocol distribution. As an example, a distribution message may comprise an OSPF message.

In certain embodiments, path messages 42 similar to those previously communicated in network system 10 are periodically communicated downstream through a particular path in order to “refresh” path information, link state information, and/or committed resources at each node 22. In such embodiments, nodes 22 may delete or “tear down” previously-stored path information, link state information, and/or committed resource parameters unless such information is regularly refreshed within a refresh timeout threshold.

According to certain embodiments of the present disclosure, each node 22 may communicate a heartbeat or “hello” message 46 to its neighboring nodes. Heartbeat messages 46 may be communicated at periodic intervals, and the receipt or non-receipt by a node 22 of heartbeat messages 46 may indicate an operational status of each of its neighboring nodes 22. For example, receipt of a heartbeat message 46 may indicate to a receiving node 22 that its neighboring node 22 is functioning correctly and/or properly coupled to the receiving node 22. As another example, non-receipt of a heartbeat message 46 may indicate to a non-receiving node 22 that its neighboring node 22 is in a fault state (e.g., power failure, restart, and/or other failure) and/or is not properly coupled to the neighboring node 22.

Modifications, additions, or omissions may be made to network system 10 without departing from the scope of the invention. The components of network system 10 may be integrated or separated according to particular needs. Moreover, the operations of network system 10 may be performed by more, fewer, or other devices. Additionally, operations of network system 10 may be performed using any suitable logic. As used in this document, “each” refers to each member of a set or each member of a subset of a set.

When a particular node 22 experiences a fault condition or failure, path information and/or link state information (including, if applicable, parameters regarding committed resources) may be lost by database 32 and/or another component of the node 22. In traditional network systems, a recovering node 22 may rely on a neighboring upstream node 22 to recover path information and/or link state information. As discussed above, a node 22 experiencing a fault may cease communicating its heartbeat message 46. In response to failing to detect a heartbeat message 46 from the faulting node 22 for a certain fault detection timeout threshold, a node 22 upstream of faulting node 22 may determine that the faulting node 22 may need recovery assistance. Accordingly, when the upstream node 22 again receives a heartbeat message 46 indicating that the faulting/recovering node 22 is no longer experiencing a fault, upstream node 22 may communicate recovery information to the recovering node 22. In certain embodiments, this information may be communicated in the form of a path message 42 with a flag or variable set indicating that the path message 42 includes recovery information for the recovering node 22. Using this recovery information (which may include, without limitation, path information, link state information, and/or parameters regarding committed resources) recovering node 22 may be able to recover its pre-fault state without deleting or tearing down pre-existing link states cross connects 28 and/or resource commitments associated with its network element 24.

However, recovery based on this traditional scheme often fails because the upstream node 22 fails to detect the recovery condition of the faulting/recovering node 22 or otherwise fails to communicate recovery information to the faulting/recovering node 22. For example, failure to detect the recovery condition may occur because the faulting/recovering node 22 becomes operational so quickly that its upstream node 22 does not detect a fault within the fault detection timeout threshold (e.g., the pre-fault and post-fault heartbeat messages 46 from the recovering node 22 are both received within the fault detection timeout threshold). In this situation, the upstream node may fail to communicate recovery information to the recovering node 22. Instead, a recovering node 22 may receive a path message 42 without the recovery information. In certain embodiments, such a path message 42 may include an ordinary path message with a flag set indicating that path message 42 includes recovery information. Due to the lack of recovery information, recovering node 22 may process the path message 42 as requesting a new path and/or new resources, rather than processing the path message 42 as including information regarding pre-fault path state and/or resource commitments, which may require re-allocation of resources at node 2. For example, such re-allocation may fail due to resource conflict and/or cause the allocation of undesirable resources with pre-fault resources remaining, in effect, stranded. In RSVP, resource allocation failure may cause path states and associated resources to be removed. Consequently, undesirable communication delay or interruption may occur in network system 10.

As another example, an upstream node 22 may fail to communicate recovery information to recovering node 22 within a recovery window for recovering node 22 when the communication path between the recovering node 22 and its upstream node 22 becomes faulty. Accordingly, if the recovering node 22 fails to receive recovery information within a certain time threshold (e.g., the node's refresh time threshold), it may tear down pre-fault committed resources, thus potentially inducing undesirable communication delay in network system 10.

FIG. 2 is a flowchart illustrating one embodiment of a method of recovering node state information that may be used with network system 10 of FIG. 1 to overcome the disadvantages of traditional node state recovery techniques.

The method may begin at step 102, where a node of network system (e.g., node 22 of network system 10) may experience a fault condition. After the fault condition is resolved, the method may proceed to step 104, where the faulting/recovering node may begin recovery.

During recovery, at step 106, the recovering node may receive a path message (e.g., a path message 42) from an upstream node. The path message may comprise, for example, an RSVP path message. At step 108, after receipt of the path message, the recovering node may compare a unique path identifier from the path message to unique path identifiers stored in a network element of recovering node (e.g., network element 24 of the recovery node). As previously discussed, certain information, including unique path identifiers associated with a node, may be stored in persistent storage of a network element, permitting the described comparison.

If, at step 110, the recovering node determines that the unique path identifier of the path message matches a unique path identifier stored in the network element, method 100 may proceed to step 112. Otherwise, if the recovering node determines that the unique path identifier of the path message does not match any unique path identifier stored in the network element, method 100 may proceed to step 118.

At step 112, in response to a determination that the unique path identifier of the path message matches a unique path identifier stored in the network element, the recovering node may compare the resource requirements of the path message to previously-committed resource parameters of the recovering node associated with the unique path identifier. As previously discussed, certain information, including previously-committed resource parameters associated with a node, may be stored in persistent storage of a network element, permitting the described comparison.

If, at step 114, the recovering node determines that the resource requirements of the path message match the previously-committed resource parameters of the unique path identifier, method 100 may proceed to step 120. Otherwise, if the recovering node determines that the resource requirements of the path message do not match previously-committed resource parameters associated with the unique path identifier, method 100 may proceed to step 116.

At step 116, in response to a determination that the resource requirements of the path message do not match committed resource parameters associated with the unique path identifier, the recovering node may delete or tear down the previously-committed resources associated with the unique path identifier.

At step 118, in response to a determination that the unique path identifier of the path message does not match any unique path identifier stored in a network element of the recovering node, or following the recovering node's tear down of previously-committed resources, the recovering node may process the path message as a new path setup request (e.g., as if the path message does not include recovery information), and accordingly establish a communications channel through the recovering node based on path information set forth in the path message using resources other than the previously-committed resources. The recovering node may additionally update path information, link state information, and/or committed resources parameters of the recovering node and its associated upstream nodes and downstream nodes appropriately (e.g., by communicating path messages to its downstream nodes and return messages to its upstream nodes as appropriate). After completion of step 118, method 100 may end.

At step 120, in response to a determination that the resource requirements of the path message match committed resource parameters associated with the unique path identifier, the recovering node may recover using the previously-committed resources for the unique path identifier and process the path message 42 as if were a path message including recovery information (e.g., path message 42 may be processed as if it has a flag set indicating that the presence of recovery information). The recovering node may accordingly establish a communications channel using the previously-committed resources through the recovering node based on path information set forth in the path message. The recovering node may additionally update path information and link state information of the recovering node and its associated upstream nodes and downstream nodes appropriately (e.g., by communicating path messages to its downstream nodes and return messages to its upstream nodes as appropriate). After completion of step 120, method 100 may end.

Modifications, additions, or omissions may be made to the method without departing from the scope of the invention. The method may include more, fewer, or other steps. Additionally, steps may be performed in any suitable order without departing from the scope of the invention.

Certain embodiments of the invention may provide one or more technical advantages. A technical advantage of one embodiment may be that a node may recover its path state after a fault in a manner independent from its upstream neighbor node's ability to detect the fault condition of the faulting/recovering node and/or the upstream neighbor node's ability to successfully communicate recovery information to the recovering node. By leveraging information stored in a network element or data plane of a recovering node, the recovering node may be able to recover its state without communicating the fault condition to its upstream neighbor node or receiving recovery information from the upstream neighbor node. Such an approach may reduce the occurrence of degraded network performance associated with traditional approaches to state recovery.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for recovering state information for a node in a communication network, comprising:
receiving a path message after an occurrence of a fault condition at the node;
comparing a unique path identifier associated with the path message to at least one stored unique path identifier;
in response to a determination that the unique path identifier associated with the path message matches at least one stored unique path identifier, comparing path resource requirements associated with the path message to previously-committed resources associated with the at least one stored unique path identifier; and
in response to a determination that the path resource requirements associated with the path message match previously-committed resources associated with the at least one stored unique path identifier, maintaining a communications channel through the node using the previously-committed resources and based on path information set forth in the path message.

2. The method of claim 1, wherein the path message comprises a Resource Reservation Protocol (RSVP) path message.

3. The method of claim 1, further comprising processing the path message as if the path message does not include recovery information in response to a determination that the unique path identifier associated with the path message does not match at least one stored unique path identifier.

4. The method of claim 1, further comprising establishing a communications channel through the node using resources other than the previously-committed resources and based on path information set forth in the path message in response to a determination that the path resource requirements associated with the path message do not match previously-committed resources associated with the at least one stored unique path identifier.

5. The method of claim 4, further comprising tearing down the previously-committed resources in response to a determination that the path resource requirements associated with the path message do not match previously-committed resources associated with the at least one stored unique path identifier.

6. The method of claim 1, wherein the path message is received from a second node upstream of the node.

7. The method of claim 6, wherein the second node is configured to communicate recovery information to the node upon expiration of a timer indicative of the fault condition of the node.

8. The method of claim 7, wherein the recovery information comprises a flag set within the path message.

9. The method of claim 1, wherein at least one of the previously-committed resources and the at least one stored unique path identifier are stored in persistent storage.

10. The method of claim 9, wherein the persistent storage is integral to the node.

11. A communication network operable to recover state information for a node, comprising:
a plurality of nodes comprising at least a first node and a second node upstream of the first node;
the first node operable to:
receive a path message from the second node after an occurrence of a fault condition at the first node;
compare a unique path identifier associated with the path message to at least one stored unique path identifier;
in response to a determination that the unique path identifier associated with the path message matches at least one stored unique path identifier, compare path resource requirements associated with the path message to previously-committed resources associated with the at least one stored unique path identifier; and
in response to a determination that the path resource requirements associated with the path message match previously-committed resources associated with the at least one stored unique path identifier, maintain a communications channel through the first node using the previously-committed resources and based on path information set forth in the path message.

12. The communication network of claim 11, wherein the path message comprises a Resource Reservation Protocol (RSVP) path message.

13. The communication network of claim 11, the first node further operable to process the path message as if the path message does not include recovery information in response to a determination that the unique path identifier associated with the path message does not match at least one stored unique path identifier.

14. The communication network of claim 11, the first node further operable to establish a communications channel through the first node using resources other than the previously-committed resources and based on path information set forth in the path message in response to a determination that the path resource requirements associated with the path message do not match previously-committed resources associated with the at least one stored unique path identifier.

15. The communication network of claim 14, the first node further operable to tear down the previously-committed resources in response to a determination that the path resource requirements associated with the path message do not match previously-committed resources associated with the at least one stored unique path identifier.

16. The communication network of claim 11, wherein at least one of the previously-committed resources and the at least one stored unique path identifier are stored in persistent storage.

17. The communication network of claim 16, wherein the persistent storage is integral to the first node.

18. The communication network of claim 11, wherein the second node is configured to communicate recovery information to the first node upon expiration of a timer indicative of the fault condition of the first node.

19. The communication network of claim 18, wherein the recovery information comprises a flag set within the path message.

20. Logic for recovering state information for a node, the logic embodiment in a medium and operable to:
receive a path message after an occurrence of a fault condition at a node;
compare a unique path identifier associated with the path message to at least one stored unique path identifier;
in response to a determination that the unique path identifier associated with the path message matches at least one stored unique path identifier, compare path resource requirements associated with the path message to previously-committed resources associated with the at least one stored unique path identifier; and
in response to a determination that the path resource requirements associated with the path message match previously-committed resources associated with the at least one stored unique path identifier, maintain a communications channel through the node using the previously-committed resources and based on path information set forth in the path message.

21. The logic of claim 20, wherein the path message comprises a Resource Reservation Protocol (RSVP) path message.

22. The logic of claim 20, further operable to process the path message as if the path message does not include recovery information in response to a determination that the unique path identifier associated with the path message does not match at least one stored unique path identifier.

23. The logic claim 20, further operable to establish a communications channel through the node using resources other than the previously-committed resources and based on path information set forth in the path message in response to a determination that the path resource requirements associated with the path message do not match previously-committed resources associated with the at least one stored unique path identifier.

24. The logic claim 23, further operable to tear down the previously-committed resources in response to a determination that the path resource requirements associated with the path message do not match previously-committed resources associated with the at least one stored unique path identifier.
